(19) United States
(12) Patent Application Publication
(10) Pub. No.: US 2022/0184534 A1
(43) Pub. Date: Jun. 16, 2022

(54) PRESSURE FILTER DEWATERING SYSTEM AND DEWATERING METHOD

(71) Applicant: Lifeng Li, Hengshui City (CN)

(72) Inventor: Lifeng Li, Hengshui City (CN)

(21) Appl. No.: 17/527,275

(22) Filed: Nov. 16, 2021

(30) Foreign Application Priority Data
Dec. 16, 2020 (CN) 202011485865.3
Dec. 16, 2020 (CN) 202023038527.3

(51) Int. Cl. B01D 25/164; B01D 35/18; B01D 35/16

(52) U.S. Cl. CPC B01D 25/164; B01D 2201/204; B01D 35/16; B01D 35/185

(57) ABSTRACT

A pressure filter dewatering system and a method, which includes a pressure filter, an extrusion dewatering assembly, and a negative pressure dewatering assembly. The pressure filter includes a plurality of filter plates and filter cloth; a first chamber used for accommodating a solid medium to form a filter cake can be formed between adjacent filter plates; a liquid inlet hole allowing suspension liquid to enter the first chamber and a liquid outlet hole allowing filtrate to flow out of the first chamber are formed in each filter plate; each filter plate includes a core plate and two membranes respectively located on two sides of the core plate; a second chamber is formed between the core plate and each membrane; and a first channel and a second channel which communicate with the second chambers are arranged inside the core plate.

### CROSS REFERENCE TO RELATED APPLICATIONS

This application takes priority and claims the benefit of Chinese Patent Application No. 202011485865.3 filed on Dec. 16, 2020 and Chinese Patent Application No. 202023038527.3 filed on Dec. 16, 2020, the contents of which are herein incorporated by reference.

### BACKGROUND OF THE INVENTION

### Field of the Invention

The present disclosure relates to the technical field of dewatering, in particular to a pressure filter dewatering system and a dewatering method.

### Description of the Related Art

A pressure filter is industrial equipment used for solid-liquid separation. It is the main dewatering equipment for environmental protection applications and is also important filter equipment in minerals and machining, chemical, food, and biomedicine industries. The pressure filter includes a plurality of filter plates arranged side by side, which can be compressed by an external force to form a plurality of airtight chambers intersecting each other. When the pressure filter is used for filtration and dewatering, a positive pressure (usually 0.3-2 Mpa) is generated in a chamber through a feeding pump so that water is discharged through filter cloth of the filter plates, and a material with a certain amount of water removed forms a filter cake in the chamber; and the moisture content of the filter cake is further reduced by means of physical extrusion. The above process is mainly realized by the filter effect of the filter plates. The moisture content of the filter cake is still high, and the dewatering effect of the pressure filter is poor.

Therefore, how to solve the problems of high moisture content in the filter cake and poor dewatering effect when the pressure filter is used for dewatering in the existing art has become important technical problems to be solved by those skilled in the art.

### SUMMARY OF THE INVENTION

In order to solve, at least to some extent, the problems in the related art, the present disclosure provides a pressure filter dewatering system and a dewatering method.

The present disclosure is achieved below: A pressure filter dewatering system includes:

a pressure filter including a plurality of filter plates arranged side by side and capable of getting close to or away from each other, and filter cloth wrapping the filter plates, wherein a first chamber used for accommodating a solid medium to form a filter cake may be formed between adjacent filter plates; a liquid inlet hole for allowing suspension liquid to enter the first chamber and a liquid outlet hole for allowing filtrate to flow out of the first chamber are formed in each filter plate; each filter plate includes a core plate and two membranes respectively located on two sides of the core plate; a second chamber is formed between the core plate and each membrane; a first channel and a second channel which communicate with the second chambers are arranged inside the core plate;

an extrusion dewatering assembly used for physically extruding the filter cake in the first chamber, wherein the extrusion dewatering assembly includes a hot water inlet pipe communicating with the first channel and a hot water outlet pipe communicating with the second channel, and the hot water outlet pipe is provided with a first valve; and

a negative pressure dewatering assembly used for generating a negative pressure in the first chamber and communicating with the liquid outlet hole.

Preferably, a drainage pipe is further included. The drainage pipe includes a first branch pipe, a second branch pipe, and a third branch pipe communicating with all the liquid outlet holes; the negative pressure dewatering assembly includes a vacuum pump arranged on the second branch pipe; the first branch pipe is provided with a second valve; and the second branch pipe is provided with a third valve.

Preferably, a steam-water separator is further arranged between the third valve and the vacuum pump; and a vapor outlet of the steam-water separator communicates with the vacuum pump.

Preferably, the extrusion dewatering assembly includes a water trough, a heating assembly used for heating water inside the water trough, and a water pump arranged on the hot water inlet pipe; and one end of the hot water inlet pipe extends into the water trough.

Preferably, an air blowing assembly used for blowing out water in the filter cake is further included. The air blowing assembly communicates with the first chamber.

Preferably, the air blowing assembly includes an air compressor and an air storage tank; and the air compressor, the air storage tank, and the liquid outlet holes communicate with each other through connection pipelines.

Preferably, the liquid outlet holes include a first liquid outlet hole and a second liquid outlet hole; the third branch pipe connected with the first liquid outlet hole and the connection pipeline are disposed in parallel; the third branch pipe is provided with a fourth valve; and the connection pipeline is provided with a fifth valve.

Preferably, the filter plates are diaphragm filter plates.

Preferably, the tail end of the hot water outlet pipe extends into the water trough.

A second aspect of the present disclosure provides a dewatering method. Based on the above-mentioned pressure filter dewatering system, the method includes the following steps:

compressing all the filter plates with the filter cloth to form the first chamber;

pressing the suspension liquid into the first chamber, discharging the filtrate through the liquid outlet holes, and collecting the solid medium in the first chamber to form the filter cake;

closing the first valve, feeding hot water into the second chamber, physically extruding the filter cake, and heating the filter cake;

vacuumizing the first chamber by means of the negative pressure dewatering assembly so that the negative pressure is generated in the first chamber; and

pulling the filter plates open to discharge the filter cake.

The technical solutions provided by the present disclosure include the following beneficial effects.

The pressure filter dewatering system provided by the present disclosure includes a pressure filter, an extrusion dewatering assembly, and a negative pressure dewatering assembly. The pressure filter includes a plurality of filter plates arranged side by side, and filter cloth wraps the filter plates. All the filter plates can be close to or away from each other. When all the filter plates are close to each other and in a compressed state, a first chamber is formed between adjacent filter plates and used for accommodating a solid medium; a liquid inlet hole for allowing suspension liquid to enter the first chamber and a liquid outlet hole for allowing filtrate to flow out of the first chamber are formed in each filter plate; the liquid inlet holes of all the filter plates communicate with each other, and the liquid outlet holes of all the filter plates communicate with each other; after the suspension liquid enters the first chamber through the liquid inlet hole, filtrate passing through the filter cloth is discharged out of the pressure filter via the liquid outlet hole due to the action of the filter cloth; and the solid medium is collected in the first chamber to form a filter cake, thus completing preliminary filtering. Each filter plate includes a core plate and two membranes respectively located on two sides of the core plate; a second chamber is formed between the core plate and each membrane; and a first channel and a second channel which communicate with the second chambers are arranged inside the core plate. The extrusion dewatering assembly is used for physically extruding the filter cake in the first chamber, and specifically includes a hot water inlet pipe and a hot water outlet pipe; and the hot water inlet pipe communicates with the first channel. The hot water outlet pipe communicates with the second channel and is provided with a first valve. The first valve is closed, and hot water is fed into the second chamber. The membranes deform to extrude the first chamber and the filter cake in the first chamber. Part of the water in the filter cake is discharged from the liquid outlet hole under the action of physical extrusion, thus completing a physical extrusion process, and the moisture content is further reduced. The first chamber and the filter cake in the first chamber are also heated while the hot water is fed into the second chambers to physically extrude the filter cake. As the temperature of the first chamber and the filter cake in the first chamber rises, the evaporation speed of the water on the surface of the filter cake increases. The above negative pressure dewatering assembly is used for generating a negative pressure in the first chamber, so that the boiling point of the water in the first chamber can be lowered, and the water in the filter cake is quickly vaporized at a relatively low temperature and pumped out from the first chamber, thus completing a negative pressure dewatering process. By such arrangement, after the preliminary filtering of the filter cloth of the pressure filter, the extrusion dewatering assembly and the negative pressure dewatering assembly are comprehensively used to further discharge the water, so as to reduce the moisture content and enhance the dewatering effect.

The present disclosure further provides a dewatering method based on the above-mentioned pressure filter dewatering system, including the following steps: firstly, compressing all the filter plates with the filter cloth to form the first chamber; pressing the suspension liquid into the first chamber, discharging the filtrate out of the pressure filter through the liquid outlet holes under the action of the filter cloth, and collecting the solid medium in the first chamber to form the filter cake; then closing the first valve, feeding hot water into the second chambers, extruding the filter cake in the first chamber by the deformation of the membranes to further discharge the water, the hot water having a heating effect on the filter cake while physically extruding the filter cake, so as to promote the water evaporation on the surface of the filter cake; vacuumizing the first chamber by means of the negative pressure dewatering assembly to generate a negative pressure in the first chamber and lower the boiling point of the water in the first chamber so that the water in the filter cake is quickly vaporized at a relatively low temperature and then discharged out of the first chamber, thus further reducing the moisture content of the filter cake; and finally, pulling the filter plates open to discharge the filter cake in the first chamber. As such, on the basis of preliminary filtering of the filter cloth, the moisture content is further reduced, and the dewatering effect is enhanced. In addition, the boiling point of the water is lowered by means of vacuumizing treatment; the hot water can meet the requirement of a heating temperature; in the process of physical extrusion with the hot water, heating for the filter cake is completed, so that the time and energy are saved, the dewatering efficiency is favorably improved, and the independent heating process is avoided.

It should be understood that the above general description and the following detailed description are exemplary and explanatory only, and are not intended to limit the present disclosure.

### BRIEF DESCRIPTION OF THE DRAWINGS

In order to describe the embodiments of the present disclosure or the technical solutions in the existing art more clearly, drawings required to be used in the embodiments or the illustration of the existing art will be briefly introduced below. Obviously, the drawings in the illustration below are only some embodiments of the present disclosure. Those ordinarily skilled in the art also can acquire other drawings according to the provided drawings without doing creative work.

FIG. 1 is a schematic structural diagram of a pressure filter dewatering system illustrated according to the embodiments of the present disclosure;

FIG. 2 is a sectional diagram of a filter plate illustrated according to the embodiments of the present disclosure;

FIG. 3 is a schematic structural diagram illustrating that a plurality of filter plates are in a compressed state according to the embodiments of the present disclosure; and

FIG. 4 is a flowchart of a dewatering method illustrated according to the embodiments of the present disclosure.

### REFERENCE SIGNS IN THE DRAWINGS

1: pressure filter; 2: filter plate; 3: first chamber; 4: liquid inlet hole; 5: core plate; 6: membrane; 7: second chamber; 8: first channel; 9: second channel; 10: hot water inlet pipe; 11: hot water outlet pipe; 12: first valve; 13: first branch pipe; 14: second branch pipe; 15: third branch pipe; 16: vacuum pump; 17: second valve; 18: third valve; 19: steam-water separator; 20: water trough; 21: water pump; 22: air compressor; 23: air storage tank; 24: connection pipeline; 25: fourth valve; and 26: fifth valve.

### DETAILED DESCRIPTION OF THE SEVERAL EMBODIMENTS

In order to make the purposes, technical solutions and advantages of the present disclosure clearer, the technical solutions of the present disclosure will be described in detail below. It is apparent that the described embodiments are a part of the embodiments of the present disclosure, not all the embodiments. Based on the embodiments in the present disclosure, all other embodiments obtained by those of ordinary skill in the art without creative efforts shall fall within the protection scope of the present disclosure.

This specific implementation mode aims to provide a pressure filter dewatering system, which solves the problems of relatively high moisture content in a filter cake and poor dewatering effect due to the use of a pressure filter in the existing art. This specific implementation mode further aims to provide a dewatering method based on the above pressure filter dewatering system.

The embodiments are illustrated below with reference to the accompanying drawings. In addition, the embodiments shown below do not limit the content of the invention described in the claims in any way. In addition, all the contents of the configuration shown in the following embodiments are not limited to necessarily serving as a solution to the invention described in the claims.

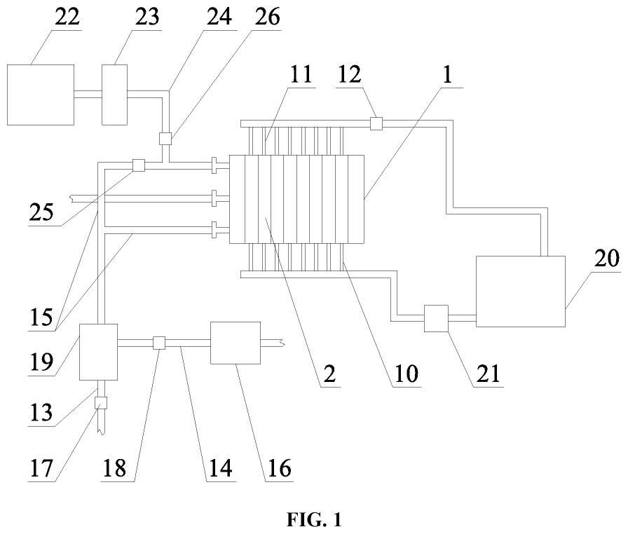

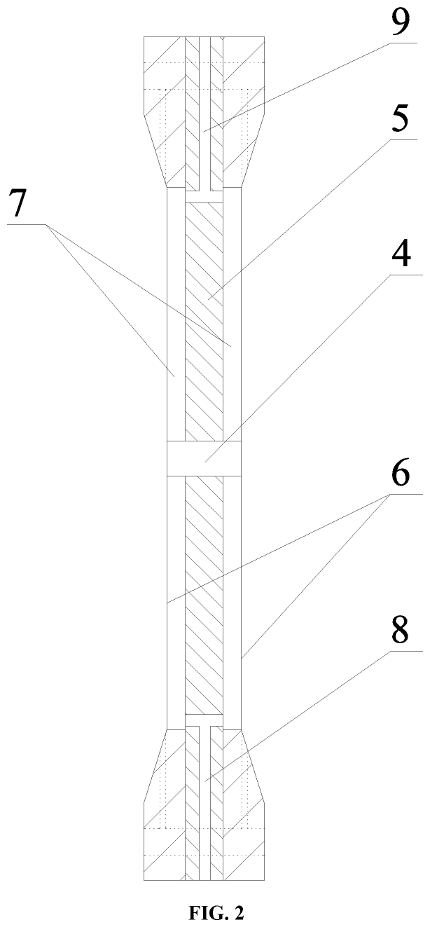

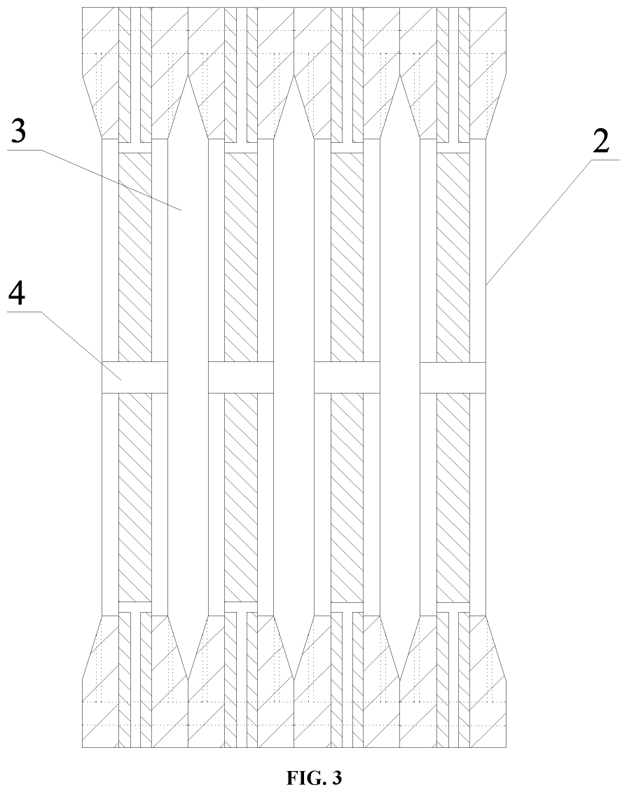

Referring to FIG. 1 to FIG. 3, schematic structural diagrams of a pressure filter dewatering system in some exemplary embodiments are illustrated. A pressure filter dewatering system provided by the present embodiment includes a pressure filter 1, an extrusion dewatering assembly, and a negative pressure dewatering assembly. The pressure filter 1 includes a plurality of filter plates 2 arranged side by side, and filter cloth wraps the filter plates 2. All the filter plates 2 can be close to or away from each other. When all the filter plates 2 are close to each other and in a compressed state, a first chamber 3 is formed between adjacent filter plates 2 and used for accommodating a solid medium; a liquid inlet hole 4 for allowing suspension liquid to enter the first chamber 3 and a liquid outlet hole for allowing filtrate to flow out of the first chamber 3 are formed in each filter plate 2; the liquid inlet holes 4 of all the filter plates 2 communicate with each other, and the liquid outlet holes of all the filter plates 2 communicate with each other; after the suspension liquid enters the first chamber 3 through the liquid inlet hole 4, filtrate passing through the filter cloth is discharged out of the pressure filter 1 via the liquid outlet hole due to the action of the filter cloth; and the solid medium is collected in the first chamber 3 to form a filter cake, thus completing preliminary filtering.

Each filter plate 2 includes a core plate 5 and two membranes 6 respectively located on two sides of the core plate 5; a second chamber 7 is formed between the core plate 5 and each membrane 6; and a first channel 8 and a second channel 9 which communicate with the second chambers 7 are arranged inside the core plate 5. The extrusion dewatering assembly is used for physically extruding the filter cake in the first chamber 3, and specifically includes a hot water inlet pipe 10 and a hot water outlet pipe 11; the hot water inlet pipe 10 communicates with the first channel 8; the hot water outlet pipe 11 communicates with the second channel 9; the hot water outlet pipe 11 is provided with a first valve 12; the first valve 12 is closed; hot water is fed into the second chambers 7; the membranes 6 deform to extrude the first chamber 3 and the filter cake inside the first chamber 3; and part of the water in the filter cake is discharged via the liquid outlet hole under the physical extrusion, thus completing the physical extrusion process, and the moisture content is further reduced.

The first chamber 3 and the filter cake in the first chamber 3 are also heated while the hot water is fed into the second chambers 7 to physically extrude the filter cake. As the temperature of the first chamber 3 and the filter cake in the first chamber 3 rises, the evaporation speed of the water on the surface of the filter cake increases. The above negative pressure dewatering assembly is used for generating a negative pressure in the first chamber 3, so that the boiling point of the water in the first chamber 3 can be lowered, and the water in the filter cake is quickly vaporized at a relatively low temperature and pumped out from the first chamber 3, thus completing a negative pressure dewatering process.

By such arrangement, after the preliminary filtering of the filter cloth of the pressure filter 1, the extrusion dewatering assembly and the negative pressure dewatering assembly are comprehensively used to further discharge the water, so as to reduce the moisture content and enhance the dewatering effect.

It should be noted that a conclusion of a large number of experiments shows that when the temperature of the filter cake is 76 DEG C., and the pressure intensity in the first chamber 3 is −61 Kpa, the water in the first chamber 3 and the filter cake can be basically completely vaporized and pumped out; when the temperature of the filter cake is 85 DEG C., and the pressure intensity in the first chamber 3 is −43.4 Kpa, the water in the first chamber 3 and the filter cake can also be basically completely vaporized and pumped out. That is, in order to enable the water in the first chamber 3 and the filter cake to be basically completely vaporized and pumped out, if the pressure intensity in the first chamber 3 is lower, the requirement for the temperature of the filter cake is lower, that is, the demand for the temperature of the hot water is lower. By overall consideration of the dewatering efficiency and actual equipment conditions, in the physical extrusion process, hot water at 60 to 85 DEG C. can be used. When the vacuum pump 16 is used for vacuumizing treatment, a negative pressure of −60 to −70 Kpa is generated in the first chamber 3. After the physical extrusion process is completed, the first valve 12 may be partially opened to discharge the hot water in the second chambers 7, and the hot water inlet pipe 10 is used to ceaselessly supply hot water to the second chambers 7. The hot water circulation can ensure that the temperature in the second chambers 7 is stable and uniform. The above hot water inlet pipe 10 and the hot water outlet pipe 11 are both hoses. When the filter plate 2 moves, the hot water inlet pipe 10 and the hot water outlet pipe 11 can freely move with it.

In the present embodiment, the dewatering system further includes a drainage pipe which includes a first branch pipe 13, a second branch pipe 14, and a third branch pipe 15 communicating with all the liquid outlet holes. The negative pressure dewatering assembly includes a vacuum pump 16. After the hot water is used to complete the physical extrusion process, the vacuum pump 16 is used to vacuumize the first chamber 3. The vacuum pump 16 is arranged on the second branch pipe 14; the first branch pipe 13 is provided with a second valve 17; and the second branch pipe 14 is provided with a third valve 18. When the vacuum pump works 16, the second valve 17 needs to be closed, and the third valve 18 is opened. In the preliminary filtering process and the physical extrusion process, the second valve 17 needs to be opened, and the third valve 18 is closed. The filtrate is directly discharged via the first branch pipe 13. The tail end of the first branch pipe 13 may be provided with a collection box used for collecting the filtrate.

During implementation, when the negative pressure dewatering assembly works, a steam-water separator 19 is further arranged between the third valve 18 and the vacuum pump 16 to avoid the vacuum pump 16 from being damaged. An inlet and a water outlet of the steam-water separator 19 both communicate with the second branch pipe 14; and a vapor outlet of the steam-water separator 19 communicates with the vacuum pump 16. When the vacuum pump 16 vacuumizes the first chamber 3, after the air and water vapor that are pumped out pass through the liquid outlet holes and the steam-water separator 19 on the second branch pipe 14, the separated liquid is discharged from the water outlet, and the vapor is discharged from the vapor outlet out of the dewatering system via the vacuum pump 16. It should be noted that the water outlet of the steam-water separator 19 may also be connected to the collection box through a pipeline.

In the present embodiment, the extrusion dewatering assembly includes a water trough 20, a heating assembly, and a water pump 21. The heating assembly is used for heating the water in the water trough 20, so as to ensure that the water temperature in the water trough 20 is kept within a range of 60-85 DEG C. One end of the hot water inlet pipe 10 extends into the water trough 20, and the water pump 21 is arranged on the hot water inlet pipe 10 and is used for pumping the hot water in the water trough 20 into the second chambers 7. A thermometer is arranged in the water trough 20, which facilitates intuitively observing whether the hot water in the water trough 20 meets the requirement. The heating assembly includes a heater, a sensor, and a controller; the heater is used for heating the water; the sensor is used for detecting the water temperature in the water trough 20; the heater and the sensor are both in communication connection with the controller; and the controller is a PLC controller. When the water temperature detected by the sensor is less than a first preset value, the controller generates a corresponding signal and transmits the signal to the heater; and the heater is electrified to heat the water in the water trough 20. When the water temperature detected by the sensor is greater than a second preset value, the controller generates a corresponding signal and transmits the signal to the heater; and the heater is powered off to stop heating the water in the water trough 20. The first preset value corresponds to the lowest temperature value of the temperature range, and the second preset value corresponds to the highest temperature value of the temperature range.

In implementation, the tail end of the hot water outlet pipe 11 extends into the water trough 20, and the hot water in the second chambers 7 may be discharged into the water trough 20. The water discharged from the second chambers 7 has a certain temperature, so as to be recycled, which saves the energy.

It should be noted that the power of an electric heater may be electric energy or solar energy. In sunny days, a solar battery panel is used to convert solar energy into electric energy or a solar water heater is used to directly heat the water. For those skilled in the art, the above technologies are mature existing technologies, so descriptions thereof are omitted. The structural principle of the heater for heating the hot water is also the mature existing technology, so descriptions thereof are omitted.

In the present embodiment, the dewatering system further includes an air blowing assembly that communicates with the first chamber 3. When the filter cloth is used to complete the preliminary filtering, the air blowing assembly is used to blow air into the first chamber 3. The air can bring away one part of the water in the first chamber 3 and the filter cake after passing through the first chamber 3 and the filter cake. Meanwhile, unfiltered materials left at the liquid inlet holes 4 in the pressure filter 1 may also be blown back into a material pool outside the pressure filter 1. When the filter plates 2 are pulled open for unloading, the unfiltered materials are prevented from being discharged together with the filter cake, which will increase the moisture content of the filter cake and affect the dewatering effect.

In implementation, the above air blowing assembly includes an air compressor 22 and an air storage tank 23; the air storage tank 23 is arranged between the air compressor 22 and the liquid outlet holes; and the air compressor 22, the air storage tank 23, and the liquid outlet holes communicate with each other through connection pipelines 24. The air storage tank 23 is assorted equipment of the air compressor 22. The air compressor 22 is used for compressing the air. The compressed air enters the air storage tank 23 for storage, which is favorable for ensuring air supply stability.

In implementation, a plurality of liquid outlet holes are provided, including a first liquid outlet hole and a second liquid outlet hole. The third branch pipe 15 connected with the first liquid outlet hole and the connection pipeline 24 of the air blowing assembly are disposed in parallel; the third branch pipe 15 is provided with a fourth valve 25; and the connection pipeline 24 is provided with a fifth valve 26. In the preliminary filtering process and the physical extrusion process and during vacuumizing of the first chamber 3, the fourth valve 25 is opened, and the fifth valve 26 is closed. When the air blowing assembly is used to blow air to the filter cake, the fourth valve 25 is closed, and the fifth valve 26 is opened. After entering the first chamber 3 via the first liquid outlet hole, the compressed air brings part of the water to pass through the third branch pipe 15 and the first branch pipe 13 of the drainage pipe in sequence from the second liquid outlet hole and is then discharged.

In implementation, the filter plates 2 include a van filter plate and a diaphragm filter plate; the van filter plate and the diaphragm filter plate are arranged at an interval; the filter cake is located between the van filter plate and the diaphragm filter plate; and the deformation of the diaphragm filter plate is used to extrude the filter cake from one side of the filter cake.

In implementation, the filter plates 2 are diaphragm filter plates; the filter cake is located between the two diaphragm filter plates, and the filter cake can be extruded simultaneously from two sides of the filter cake, which is favorable for improving the dewatering effect and the dewatering efficiency.

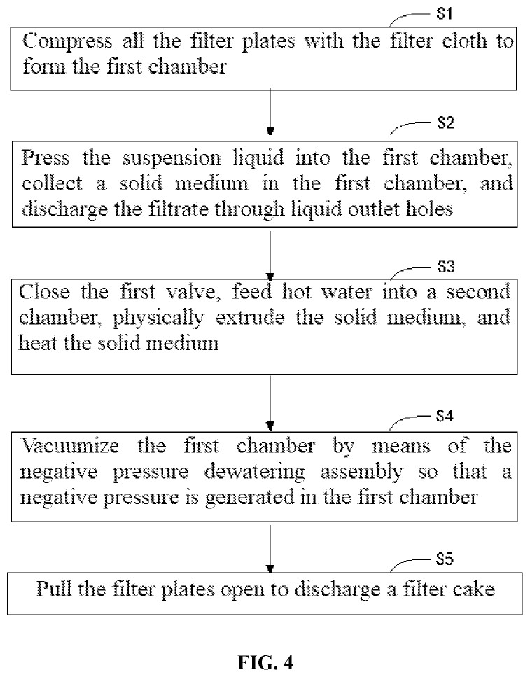

Referring to FIG. 4, this specific implementation mode further provides a dewatering method based on the above pressure filter dewatering system, including the following steps:

S1, all the filter plates with the filter cloth are compressed to form the first chamber;

S2, the suspension liquid is pressed into the first chamber, the filtrate is discharged through the liquid outlet holes, and the solid medium is collected in the first chamber to form the filter cake;

S3, the first valve is closed, hot water is fed into the second chamber, and the filter cake is physically extruded and heated at the same time;

S4, the first chamber is vacuumized by means of the negative pressure dewatering assembly so that the negative pressure is generated in the first chamber; and

S5, the filter plates are pulled open to discharge the filter cake.

When the pressure filter dewatering system is used for dewatering, firstly, all the filter plates 2 with the filter cloth are compressed to form the first chamber 3; the suspension liquid is pressed into the first chamber 3; the filtrate is discharged out of the pressure filter 1 through the liquid outlet holes under the action of the filter cloth; the solid medium is collected in the first chamber 3 to form the filter cake; the first valve 12 is then closed; hot water is fed into the second chambers 7; the filter cake in the first chamber 3 is extruded by the deformation of the membranes 6 to further discharge the water; the hot water has a heating effect on the filter cake while physically extruding the filter cake, so as to promote the water evaporation on the surface of the filter cake; the first chamber 3 is vacuumized by means of the negative pressure dewatering assembly to generate a negative pressure in the first chamber 3 and lower the boiling point of the water in the first chamber 3 so that the water in the filter cake is quickly vaporized at a relatively low temperature and then discharged out of the first chamber 3, thus further reducing the moisture content of the filter cake; and finally, the filter plates 2 are pulled open to discharge the filter cake in the first chamber 3. By means of the above-mentioned dewatering method, on the basis of the preliminary filtering of the filter cloth, the moisture content is further reduced, and the dewatering effect is enhanced. In addition, the boiling point of the water is lowered by means of vacuumizing treatment; the hot water can meet the requirement of a heating temperature; in the process of physical extrusion with the hot water, heating for the filter cake is completed, so that the time and energy are saved, the dewatering efficiency is favorably improved, and the independent heating process is avoided.

The above descriptions are only specific implementation modes of the present disclosure, but the protection scope of the present disclosure is not limited to this. Any person skilled in the art can easily think of changes or replacements within the technical scope disclosed by the present disclosure. The changes or replacements should be covered by the protection scope of the present disclosure. Therefore, the protection scope of the present disclosure should be subject to the protection scope of the claims.

What is claimed is:

1. A pressure filter dewatering system, comprising:
a pressure filter (1) comprising a plurality of filter plates (2) arranged side by side and capable of getting close to or away from each other, and filter cloth wrapping the filter plates (2), wherein a first chamber (3) used for accommodating a solid medium to form a filter cake may be formed between adjacent filter plates (2); a liquid inlet hole (4) for allowing suspension liquid to enter the first chamber (3) and a liquid outlet hole for allowing filtrate to flow out of the first chamber (3) are formed in each filter plate (2); each filter plate (2) comprises a core plate (5) and two membranes (6) respectively located on two sides of the core plate (5); a second chamber (7) is formed between the core plate (5) and each membrane (6); a first channel (8) and a second channel (9) which communicate with the second chambers (7) are arranged inside the core plate (5);
an extrusion dewatering assembly used for physically extruding the filter cake in the first chamber (3), wherein the extrusion dewatering assembly comprises a hot water inlet pipe (10) communicating with the first channel (8) and a hot water outlet pipe (11) communicating with the second channel (9), and the hot water outlet pipe (11) is provided with a first valve (12); and
a negative pressure dewatering assembly used for generating a negative pressure in the first chamber (3) and communicating with the liquid outlet hole.

2. The pressure filter dewatering system according to claim 1, further comprising a drainage pipe, wherein the drainage pipe comprises a first branch pipe (13), a second branch pipe (14), and a third branch pipe (15) communicating with all the liquid outlet holes; the negative pressure dewatering assembly comprises a vacuum pump (16) arranged on the second branch pipe (14); the first branch pipe (13) is provided with a second valve (17); and the second branch pipe (14) is provided with a third valve (18).

3. The pressure filter dewatering system according to claim 2, wherein a steam-water separator (19) is further arranged between the third valve (18) and the vacuum pump (16); and a vapor outlet of the steam-water separator (19) communicates with the vacuum pump (16).

4. The pressure filter dewatering system according to claim 1, wherein the extrusion dewatering assembly comprises a water trough (20), a heating assembly used for heating water inside the water trough (20), and a water pump (21) arranged on the hot water inlet pipe (10); and one end of the hot water inlet pipe (10) extends into the water trough (20).

5. The pressure filter dewatering system according to claim 2, further comprising an air blowing assembly used for blowing out water in the filter cake, wherein the air blowing assembly communicates with the first chamber (3).

6. The pressure filter dewatering system according to claim 5, wherein the air blowing assembly comprises an air compressor (22) and an air storage tank (23); and the air compressor (22), the air storage tank (23), and the liquid outlet holes communicate with each other through connection pipelines (24).

7. The pressure filter dewatering system according to claim 6, wherein the liquid outlet holes comprise a first liquid outlet hole and a second liquid outlet hole; the third branch pipe (15) connected with the first liquid outlet hole and the connection pipeline (24) are disposed in parallel; the third branch pipe (15) is provided with a fourth valve (25); and the connection pipeline (24) is provided with a fifth valve (26).

8. The pressure filter dewatering system according to claim 1, wherein the filter plates (2) are diaphragm filter plates.

9. The pressure filter dewatering system according to claim 4, wherein the tail end of the hot water outlet pipe (11) extends into the water trough (20).

10. A dewatering method based on the pressure filter dewatering system according to claim 1, comprising the following steps:
compressing all the filter plates with the filter cloth to form the first chamber;
pressing the suspension liquid into the first chamber, discharging the filtrate through the liquid outlet holes, and collecting the solid medium in the first chamber to form the filter cake;
closing the first valve, feeding hot water into the second chamber, physically extruding the filter cake, and heating the filter cake;
vacuumizing the first chamber by means of the negative pressure dewatering assembly so that the negative pressure is generated in the first chamber; and
pulling the filter plates open to discharge the filter cake.
